(19) United States
(12) Patent Application Publication
(10) Pub. No.: US 2010/0271958 A1
(43) Pub. Date: Oct. 28, 2010

(54) METHOD OF DETECTING AND LOCATING A LOSS OF CONNECTIVITY WITHIN A COMMUNICATION NETWORK

(75) Inventors: Patrick Dillon, Versailles (FR); Santo Suy, Rungis (FR)

Correspondence Address: STROOCK & STROOCK & LAVAN LLP, 180 MAIDEN LANE, NEW YORK, NY, 10038, US

(73) Assignee: Thales, Neuilly Sur Seine (FR)

(21) Appl. No.: 12/769,312

(22) Filed: Apr. 28, 2010

(30) Foreign Application Priority Data
Apr. 28, 2009 (FR) 0902069

(51) Int. Cl. H04L 12/26

(52) U.S. Cl. 370/242

(57) ABSTRACT

Method of detecting a fault within a redundant communication network including transmitting a first stream of monitoring frames from its main interface P_{A} destined for its standby interface P_{B}, transmitting a second stream of monitoring frames from its standby interface P_{B} destined for its main interface P_{A}, and decision step determining connectivity of the communication network.

### CROSS REFERENCE TO RELATED APPLICATIONS

Priority is claimed to French Patent Application No. 0902069, filed on Apr. 28, 2009, which is hereby incorporated by reference in its entirety.

### BACKGROUND OF THE INVENTION

1. Field of the Invention

The present invention relates to a method of detecting and locating a fault causing a loss of unidirectional or bidirectional connectivity on a link between two entities of a communication network.

It applies for example within the framework of computer-based systems having a requirement for very high availability such as an air traffic control system and more particularly to a redundant local area communication network of Ethernet type.

In such a system, the level of availability of the communication network which ensures the transport of data between the various calculation units making up the system must be very considerable. The system failure rate must be guaranteed to be very close to zero with a duration for detecting, locating and replacing the failed item of equipment which must not exceed thirty minutes. This is why, in this context, it is preferable to be able to detect a fault occurring on a link between two entities of the communication network as well as to precisely locate the link affected by this fault so as to increase the system's overall availability level. A fault may have various causes; it is possible to cite for example a unidirectional severing of communication within the network interface card of a calculation unit, a severing of communication within an item of network equipment, a failure of the integrity of the network or else a fault with the standby link of a calculation unit.

2. Description of the Prior Art

To achieve a considerable level of availability in a communication network, it is known to implement architectures of redundant and meshed networks comprising network equipment to which calculation units are connected by redundant links. In particular, so-called local area networks using Ethernet technology are constructed according to a network architecture which comprises at least two sets of network equipment linked together by several resilient links. Each calculation unit is thereafter linked to the two sets by two distinct links. By using two connection links it is possible to increase the reliability of the link by rendering it redundant. This type of architecture is known to the person skilled in the art by the term “cooperation of network interfaces”. At a given instant, one of the two links is active and the other link is inactive; it is called the standby link. Prior art solutions implement fault detection solely on the so-called active link. The mechanisms most often used are based on monitoring the physical state of the link between the calculation unit and the network item of equipment as well as on monitoring the receipt of data. These mechanisms can also be supplemented with the dispatching, sometimes systematic, of echo messages known by the term “ping” in order to confirm the detection of a fault.

The existing solutions exhibit numerous drawbacks. Generally, the standby link is never monitored; there is no mechanism for detecting a fault occurring on the level-2 layer implemented on this link so as to trigger preventive maintenance. Neither is location of the fault within the network implemented, though this would allow an appropriate reconfiguration decision and/or better reactivity of the maintenance operations. Concerning the monitoring of the physical state of the equipment, partial faults internal to the interface cards of the calculation units or to the network equipment itself are not detected. The expression partial fault means a fault affecting the link between two hardware components of the interface card, in particular between a component embodying the physical layer and a component embodying the level-two layer or MAC (Medium Access Control) layer. Moreover, the principle of data reception monitoring gives rise to certain drawbacks such as a considerable false alarm rate in the case of absence of traffic destined for the calculation unit or non-detection of send faults. Finally, the dispatching of echo messages induces considerable pollution of the network since these messages are dispatched by broadcasting to all the network calculation units.

The method according to the invention makes it possible to detect certain types of faults which are not taken into account by the prior art solutions such as a loss of unidirectional connectivity of an active link and of a standby link, whatever the origin of the fault, in particular when the latter is internal to a network interface card. This method also makes it possible, in the case of fault detection, to locate this fault within the communication network. The detection of all the communication faults between redundant links and in particular those affecting the standby link of the calculation unit as well as the locating thereof contribute directly to increasing the availability of the communication network.

### SUMMARY OF THE INVENTION

For this purpose, the subject of the invention is a method of detecting a fault within a redundant communication network, the said network comprising at least one first calculation unit and a group of participating calculation units each comprising at least one main network interface P_{A} and a standby network interface P_{B}, at least two access switches and at least two distribution switches, each calculation unit being linked through the said main interface P_{A} to a first access switch with the aid of a direct link and through the said standby interface P_{B} to a second access switch with the aid of a standby link, each access switch being linked to a distribution switch with the aid of an uplink, each distribution switch being linked to another distribution switch through a redundant link, the said fault causing a loss of unidirectional or bidirectional connectivity on one of the said links linking two entities of the said network, wherein the said first calculation unit successively implements the following steps:
a step of transmitting a first stream of monitoring frames from its main interface P_{A} destined for its standby interface P_{B}
a step of transmitting a second stream of monitoring frames from its standby interface P_{B} destined for its main interface P_{A}
a decision step based on the following logic:
   if the said first stream of monitoring frames is not received by the standby interface P_{B}, a loss of unidirectional connectivity affecting the communication streams originating from the main interface P_{A} or destined for the standby interface P_{B} is declared,
   if the said second stream of monitoring frames is not received by the main interface P_{A}, a loss of unidirectional connectivity affecting the communication streams originating from the standby interface P_{B} or destined for the main interface P_{A} is declared,
   if neither of the said streams of monitoring frames is received by one of the interfaces P_{A} and P_{B}, a loss of bidirectional connectivity affecting all the communication streams originating from or destined for the said first calculation unit is declared.

In a variant embodiment of the invention, the said method furthermore comprises the following steps:
A step of transmitting a stream of interrogation frames sent by the said first calculation unit having detected a loss of connectivity on at least one of its two interfaces P_{A}, the said stream having as source the said interface P_{A} and as destination each interface P_{A},P_{B} of the group of participating calculation units,
A step of transmitting streams of response frames sent by the said participating calculation units, the said streams having as source one of the two interfaces P_{A},P_{B} of the said calculation units having previously received the said stream of interrogation frames on the said interface P_{A},P_{B} and as destination the said interface of the calculation unit having previously sent the said stream of interrogation frames,
A step of combinatorial analysis locating the link affected by the said loss of connectivity on the basis of the streams of response frames received and not received by the said first calculation unit, and of the knowledge of the links traversed by the said streams of response frames.

In a variant embodiment of the invention, the group composed of the said first calculation unit and of the said participating calculation units is divided into several membership groups, each of the said membership groups grouping together the calculation units linked to the same access switches, the said combinatorial analysis using the information regarding the membership group of the calculation unit from which the said stream of responses frames originates with the aim of resolving the ambiguities in the location of the said fault.

In a variant embodiment of the invention, each of the said participating calculation units comprises a plurality of standby interfaces to which the said method is applied.

In a variant embodiment of the invention, the said redundant communication network is a meshed and redundant Ethernet network.

### BRIEF DESCRIPTION OF THE DRAWINGS

Other characteristics and advantages of the present invention will be more apparent on reading the description which follows in relation to the appended drawings which represent:

FIG. 1, a diagram illustrating an exemplary redundant and meshed network architecture,

FIG. 2, a diagram illustrating an exemplary generic architecture of a redundant and meshed local area communication network of Ethernet type comprising several calculation units,

FIG. 3, a diagram illustrating the monitoring mechanism implemented by the detection method according to the invention,

FIG. 4, a diagram illustrating the step of dispatching interrogation frames of the location method according to the invention,

FIGS. 5 and 6, two examples illustrating the step of dispatching response frames of the location method according to the invention.

### DETAILED DESCRIPTION

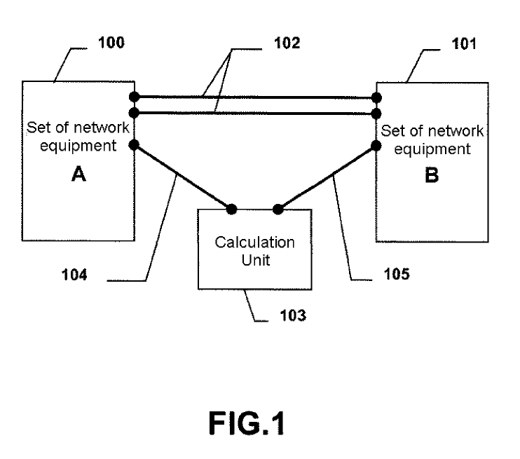

FIG. 1 functionally represents a local area network architecture, for example using Ethernet technology, comprising two sets A and B of network equipment 100,101 and at least one calculation unit 103 able to produce data to be transmitted through the network. The two sets of network equipment 100,101 have a network switch function and are connected together by several resilient links 102. Each calculation unit 103 is linked to the two sets of network equipment 100,101 by two distinct links 104,105. This type of architecture allows the implementation, by the calculation unit 103, of a functionality known to the person skilled in the art by the expression “cooperation of network interfaces”. At a given instant, one of the links 104,105 linked to the calculation unit 103 is an active link while the other link is inactive; it is called a standby link and its function is to replace the active link when the latter is defective. In the prior art solutions, the detection of a fault on the active link 104 and the decision to toggle over to the standby link 105 are effected at the level of each calculation unit 103 individually and independently of the other calculation units of the network. Most operating systems used today in the calculation units 103 implement the functionality of “cooperation of network interfaces” previously described. However this functionality exhibits limitations which can be improved so as to increase the system's overall availability level. Certain types of faults are not detected or located by the current solutions, in particular faults implicating the standby link, or those occurring within an interface card between two hardware components.

The solution afforded by the invention is based on the implementation of two mechanisms. A first monitoring mechanism makes it possible to monitor the connectivity of the network interfaces participating in the cooperation of interfaces and in the event of detection of loss of connectivity to trigger a second mechanism to locate the fault. Once triggered, this second mechanism makes it possible to locate the fault so as optionally to advise the existing supervision and management facilities of the redundancy of the network interfaces.

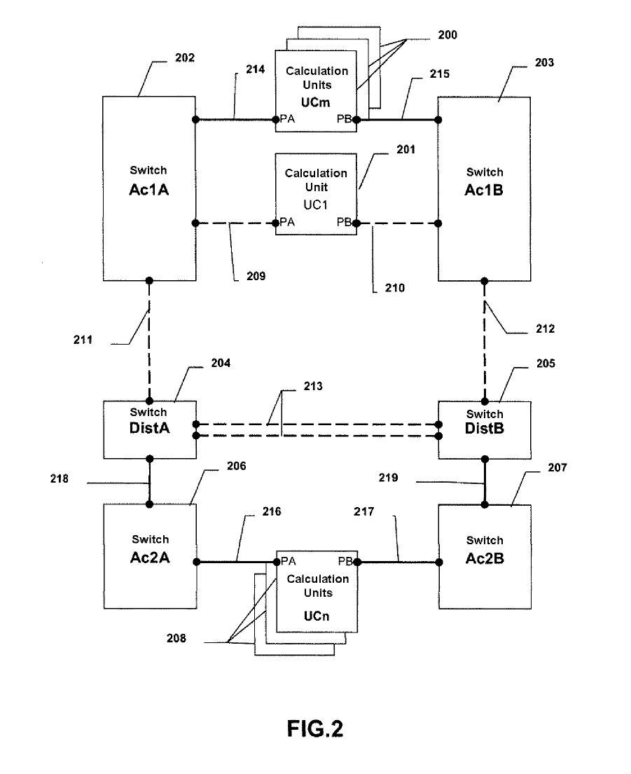

FIG. 2 shows diagrammatically the generic architecture of an Ethernet redundant local area communication network. This network is composed of several items of network equipment of switch type divided into two groups. Switches of “distribution” type 204,205 linked together by a set of redundant links 213 form a first group of equipment. Switches of “access” type 202,203,206,207 to which calculation units 200,201,208 are connected by an active link 209,214,216 and a standby link 210,215,217 form a second group of equipment. Each switch of “access” type is linked to a switch of “distribution” type by a so-called “uplink” 211,212,218,219.

By way of example and so as to illustrate the implementation of the method according to the invention, the description which follows is given in the case where the said method is implemented on the calculation unit UC1 201. This example is wholly non-limiting and extends to any other calculation unit of the network.

The faults that the method according to the invention, implemented on the calculation unit UC1 201, seeks to detect and locate are situated on the links 209,210 linking the calculation unit UC1 201 to the access switches 202,203 as well as on the links 211,212,213 linking these two access switches 202,203 to one another via the distribution switches 204,205. More precisely, the method according to the invention seeks to detect and locate the unidirectional or bidirectional stream losses occurring on these links and resulting from certain types of faults. These faults may be, for example, located within the interface cards of the calculation units or within the switches.

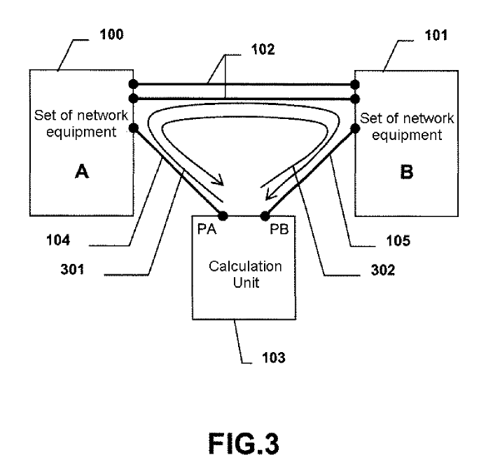

FIG. 3 illustrates the principle of the monitoring mechanism implemented by the method according to the invention. This principle is based on the periodic exchanging of monitoring frames, for example complying with the Ethernet protocol, by the calculation unit between its physical ports participating in a group of ports which comply with the “cooperation of network interfaces” functionality. The exchanging of frames which is implemented is bidirectional. In the non-limiting example of FIG. 3 the calculation unit 103 possesses two ports P_{A} and P_{B} each associated with an interface and with a link 104,105 linking the calculation unit to two sets of network equipment 100,101. A first stream 301 of monitoring frames is transmitted from the port P_{A} to the port P_{B} and a second stream 302 of monitoring frames is transmitted conversely from the port P_{B} to the port P_{A}. The two ports each possess a static MAC (Media Access Control) address, respectively named M@A and M@B. These exchanges of streams 301,302 make it possible to monitor the bidirectional connectivity of the active link 104 and of the standby link 105 as well as the operation of the bidirectional communications within the network architecture concerned 100,101,102. In order to render the communication transparent at the level of the upper layers of the network stack, it is preferable that the MAC address of the active link is always the same, this is why a so-called virtual MAC address M@V is allocated to the interface connected to the active link. The method of detecting faults according to the invention consists in implementing the dispatching of monitoring frames to the active link and then the standby link alternately. Moreover, the method makes it possible to test the connectivity of the whole of the network considered in a bidirectional manner by generating a point-to-point monitoring communication stream between the two ports of the calculation unit 103 without polluting the network. The dispatching of monitoring frames is performed at the datalink layer level thereby making it possible to transmit a stream originating from one of the interfaces of the machine and destined for another interface of the same machine. This type of communication cannot be implemented at the network layer level since, in a given network, a calculation unit is identified only by a unique network address. The monitoring frame can be a frame of Ethernet type containing, for example, a means of identifying the protocol implemented by the method according to the invention, a means of identifying that a monitoring frame is involved, the name of the calculation unit considered as well as its group number, the MAC addresses of the source and destination interfaces and a means of identifying which interface is active.

In the event of non-receipt, after several resend attempts, of the monitoring frames by one of the ports or by both ports, a loss of unidirectional or bidirectional connectivity is detected.

The detection mechanism previously described with the help of FIG. 3 does not make it possible to locate the fault which may originate, for example, from a defect of the interface card of one of the ports, one of the items of network equipment or a network equipment interlink. The detection of loss of connectivity thereafter triggers a mechanism for locating the fault according to the invention.

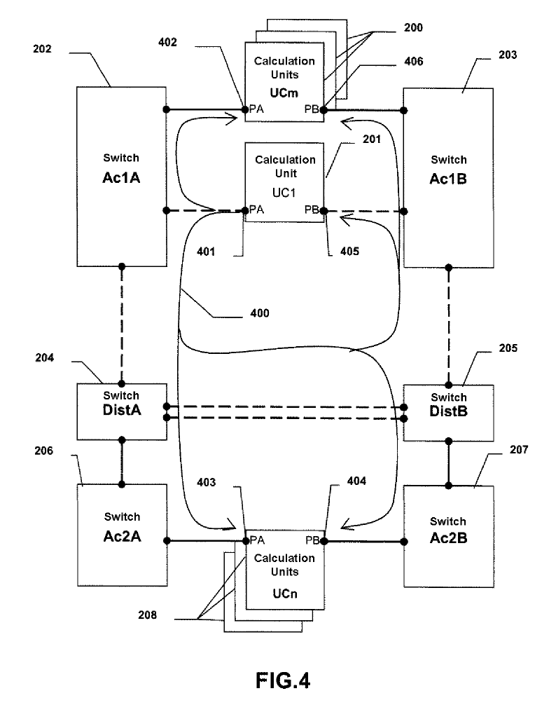

The principle of the fault location mechanism according to the invention consists in sending, from the calculation unit having previously detected the loss of connectivity, interrogation frames destined for the set of calculation units participating in the mechanism. FIG. 4 illustrates this principle. The interrogation frames 400 are dispatched from the port 401 of the calculation unit UC1 201 to the set of active ports 402,403 and standby ports 404,405,406 of the other participating calculation units 200,208 of the network, including the sender calculation unit 201.

The set of calculation units participating in the process can be determined in accordance with various criteria as a function of the architecture of the system. This set consists, for example, of a dedicated virtual local area network or “Virtual Local Access Network” within which the dispatching of the interrogation frames is performed in a broadcast mode. This first solution has the advantage of being simple to implement since all the calculation units of the virtual local area network participate in the method according to the invention. The set of participating units can also be defined as a group for which a specific addressing has previously been instigated; in this case the dispatching of the interrogation frames is done towards the said group according to a communication known as “multicast”. Finally, the static or dynamic configuration of the group of participating calculation units can also to be envisaged.

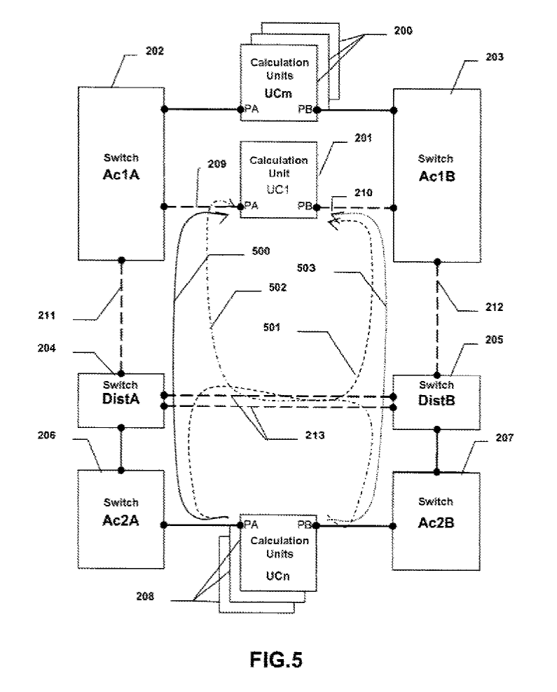

FIG. 5 illustrates the mechanism implemented during the response of the group of calculation units UCn 208 to the receipt of the interrogation frames sent by the calculation unit UC1 201. For each interrogation frame received by each of the two ports P_{A} and P_{B}, a response frame is returned to each of the two ports of the calculation unit UC₁. In the example of FIG. 5, this mechanism gives rise to the dispatching of four response streams originating from one of the calculation units of the group UCn 208. A first stream 500 is dispatched by the port P_{A} of the said unit of the group UCn 208 and passes through the link 211 linking the distribution switch DistA 204 to the access switch Ac1A 202 and then the link 209 linking the said access switch 202 to the port P_{A} of the calculation unit UC1 201. The receipt of this first stream 500 consisting of response frames allows the possible location of a fault on one of the two links 211,209 cited. In a similar manner, a second response stream 501 is transmitted from the port P_{A} of one of the units of the group UCn 208 to the port P_{B} of the unit UC1 201. This second stream 501 passes through the link 213 linking the two distribution switches 204,205 as well as the link 212 linking the distribution switch DistB 205 to the access switch Ac1B 203 and finally the link 210 linking the said access switch 203 to the calculation unit UC1 201. This second stream 501 therefore makes it possible to locate a possible fault on one of these three links. In a symmetric manner, two response streams 502,503 are sent from the port P_{B} of one of the units of the group UCn 208 to the two ports of the calculation unit UC1.

The response stream 502 makes it possible to locate a fault on one of the three links 213,211,209 while the response stream 503 allows fault location on one of the two links 212,210. The meshing of the direct and crossed response streams 500,501,502,503, responding to likewise meshed interrogation streams, makes it possible to test the connectivity of all the possible paths between the calculation unit having detected a loss of connectivity and the participating calculation units.

The fault location method according to the invention consists then in performing a combinatorial analysis of the various frames of responses received as a function of their origin so as to determine which link is defective. In order to resolve any residual ambiguity in the location of the fault, it is necessary within the set of calculation units participating in the method to define several membership groups. In the example of FIG. 5, a first membership group consists of the group of calculation units UCn 208. Combinatorial analysis of the response streams 500,501,502,503 originating from this membership group makes it possible to differentiate a fault occurring on the link 213 linking the two distribution switches 204,205 of a fault occurring between one of the two distribution switches 204,205 and the sender calculation unit UC1 201. However it does not make it possible to differentiate a loss of connectivity occurring on the link 211,212 linking a distribution switch 204,205 to an access switch 202,203 from a loss of connectivity affecting the link 209,210 linking an access switch 202,203 to the sender calculation unit UC1 201. The following chart summarizes the logic relations between the non-receipt of a stream and the location of a fault.

CHART 1
combinatorial analysis table for the first membership group

| | Location of the fault on one of the |
|---|---|
| Reference of the response stream | three groups of links G₁ = {213}, |
| not received | G₂ = {209, 211}, G₃ = {210, 212} |
| 500 | G₂ |
| 501 | G₁ or G₃ |
| 502 | G₁ or G₂ |
| 503 | G₃ |

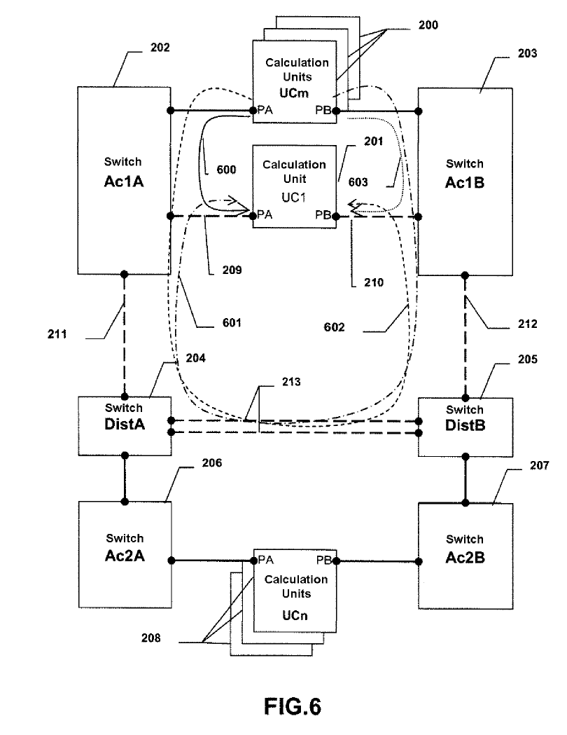

FIG. 6 illustrates the mechanism for dispatching the response frames but this time on the basis of the group of calculation units UCm 200. This second group of calculation units corresponds to a second group of memberships making it possible to resolve the previously identified ambiguities in the location of the fault. Generally the membership criterion for a calculation unit to belong to a group is determined by the connection of the said unit to a given pair of access switches. All the calculation units connected to the same pair of access switches are grouped together within the same membership group.

In a manner similar to the example of FIG. 5, the dispatching of streams of response frames 600,601,602,603 from the ports of one of the calculation units UCm 200 to the calculation unit 201 having previously sent a stream of interrogation frames makes it possible, by a combinatorial analysis method according to the invention, to discriminate the origin of a fault on one of the three groups of links which follow. The link 209 linking the calculation unit UC1 201 to the access switch Ac1A 202 is considered to be defective if the calculation unit UC1 201 does not receive either of the two response streams 600,601 dispatched by the calculation unit of the membership group UCm 200. The same decision is applied to the link 210 linking the calculation unit UC1 201 to the access switch Ac1B 203 if no response stream is received on the port P_{B} of the said unit 201. The following chart summarizes the logic relations between the non-receipt of a response stream by the calculation unit UC1 201 and the location of a fault on a link or a group of links.

CHART 2
combinatorial analysis table for the second membership group

| | Location of the fault on one of the |
|---|---|
| | three groups of links G₄ = {209}, |
| Reference of the response stream | G₅ = {210}, G₆ = {211, 213}, |
| not received | G₇ = {212, 213} |
| 600 | G₄ |
| 601 | G₄ or G₆ |
| 602 | G₅ or G₇ |
| 603 | G₅ |

The combinatorial analysis using the information regarding membership group therefore makes it possible to resolve any ambiguity in the origin of a fault on the set of links 209,210,211,212,213 considered by combining the information obtained with the aid of the receipt of the response frames originating from the various membership groups.

The interrogation and response frames can be Ethernet frames. They can contain, for example, a means for identifying the protocol implemented by the method according to the invention, a means for identifying the type of frames, the name of the calculation unit considered as well as its group number, the MAC addresses of the source and destination interfaces and a means for identifying which interface is active. The response frames can contain moreover a means for identifying the name and the MAC addresses of the interrogating calculation unit.

In order to allow complete location of the failed item of equipment, the mechanism previously described with the help of FIGS. 4, 5 and 6 is also implemented on the basis of the port 405 P_{B} thus making it possible to locate a unidirectional communication fault in the direction from P_{B} to P_{A}.

The method according to an embodiment of the invention presents notably the advantage of allowing the detection and location of faults internal to a network interface card, notably a fault occurring between a component of the physical layer and a component of the datalink layer. Faults of this type are not detected by the known solutions which implement only the monitoring of the connectivity of the physical link between two entities. Moreover the invention allows systematic monitoring of the standby link in addition to the active link, so as to anticipate a loss of connectivity affecting the standby interface.

The method according to an embodiment of the invention also presents the advantage of consuming very little of the bandwidth of the network in monitoring mode and is also more efficacious in terms of convergence time. Moreover the proposed solution is compatible with the current existing solutions and can therefore coexist within one and the same system with calculation units or other types of equipment not implementing this solution.

The invention also makes it possible, when a fault is located precisely on a link of the network considered, to trigger a toggling of the communications over to a standby link allowing the data streams to avoid the link affected by the fault. The invention thus makes it possible to restore the connectivity between the sender calculation unit and the other participating calculation units, the effect of which is to improve the reactivity of the maintenance operations and to thus increase network availability level. The invention also allows the detection and location of the defects of connectivity of the standby links before their implementation subsequent to a connectivity failure of the active link.

1. A method of detecting a fault within a redundant communication network, the network comprising at least one first calculation unit and a group of participating calculation units each comprising at least one main network interface P_{A} and a standby network interface P_{B}, at least two access switches and at least two distribution switches, each calculation unit being linked through the respective main interface P_{A} to a first one of the access switches with the aid of a direct link and through the respective standby interface P_{B} to a second one of the access switch with the aid of a standby link, each access switch being linked to a distribution switch with the aid of an uplink, each distribution switch being linked to another distribution switch through a redundant link, the fault causing a loss of unidirectional or bidirectional connectivity on one of the links linking two entities of the network, wherein the first calculation unit successively implements the following steps:
transmitting a first stream of monitoring frames from its main interface P_{A} destined for its standby interface P_{B}
transmitting a second stream of monitoring frames from its standby interface P_{B} destined for its main interface P_{A}
making a decision based on the following logic:
if the first stream of monitoring frames is not received by the standby interface P_{B}, a loss of unidirectional connectivity affecting the communication streams originating from the main interface P_{A} or destined for the standby interface P_{B} is declared,
if the second stream of monitoring frames is not received by the main interface P_{A}, a loss of unidirectional connectivity affecting the communication streams originating from the standby interface P_{B} or destined for the main interface P_{A} is declared,
if neither of the streams of monitoring frames is received by one of the interfaces P_{A} and P_{B}, a loss of bidirectional connectivity affecting all the communication streams originating from or destined for the first calculation unit is declared.

2. The method according to claim 1 further comprising the following steps:
transmitting a stream of interrogation frames from the first calculation unit having detected a loss of connectivity on at least one of its two interfaces P_{A}, the stream having as source the interface P_{A} and as destination each interface P_{A},P_{B} of the group of participating calculation units,
transmitting streams of response frames from the participating calculation units, the streams having as source one of the two interfaces P_{A},P_{B} of the calculation units having previously received the stream of interrogation frames on the interface P_{A},P_{B} and as destination the interface of the calculation unit having previously sent the stream of interrogation frames,
performing a combinatorial analysis locating the link affected by the loss of connectivity on the basis of the streams of response frames received and not received by the first calculation unit, and of the knowledge of the links traversed by the streams of response frames.

3. The method according to claim 2 wherein the group comprising the first calculation unit and the participating calculation units is divided into several membership groups, each of the membership groups grouping together the calculation units linked to the same access switches, the combinatorial analysis using the information regarding the membership group of the calculation unit from which the stream of response frames originates with the aim of resolving the ambiguities in the location of the fault.

4. The method according to claim 3 wherein each of the participating calculation units comprises a plurality of standby interfaces to which the said method is applied.

5. The method according to claim 1 wherein the redundant communication network is a meshed and redundant Ethernet network.

6. The method according to claim 2 wherein the redundant communication network is a meshed and redundant Ethernet network.

7. The method according to claim 3 wherein the redundant communication network is a meshed and redundant Ethernet network.

8. The method according to claim 4 wherein the redundant communication network is a meshed and redundant Ethernet network.
